(19) United States
(12) Patent Application Publication
(10) Pub. No.: US 2009/0027791 A1
(43) Pub. Date: Jan. 29, 2009

(54) ADJUSTABLE MIRROR DEVICE

(76) Inventor: Chi Yau Yue, Hong Kong (HK)

Correspondence Address: ERIC HANSCOM, 7395 PORTAGE WAY, CARLSBAD, CA, 92011, US

(21) Appl. No.: 11/828,348

(22) Filed: Jul. 26, 2007

(51) Int. Cl. A45D 42/00; G02B 5/08; G02B 7/182

(52) U.S. Cl. 359/875; 359/872

(57) ABSTRACT

A mirror device includes a handle portion, a connector portion, and a mirror. The handle portion has a first end and a second end having a groove. The connector portion is coupled to the handle portion and has a ball-shaped first end and a second end. The ball-shaped first end is disposed within the groove such that the connector portion may rotate with respect to the handle portion and is adjustable with respect to the second end of the handle portion such that the connector portion may be positioned vertically and perpendicularly with respect to the handle portion. The mirror is coupled to the second end of the connector portion such that the mirror may rotate in conjunction with the connector portion and may be angularly positioned with respect to the handle portion based on the angular position of the connector portion with respect to the handle portion.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND

The embodiments of the invention generally relate to the field of cosmetic devices. More specifically, the embodiments of the invention relate to a mirror device that may be converted from a handheld mirror to a self-standing mirror.

Mirrors have been used for centuries. Mirrors traditionally are categorized into two types—handheld mirrors and mirrors with stands that may reside on a table or other surface. Those who desire to have both a handheld mirror and a mirror that may stand freely on a table or other surface must purchase two mirrors, which can be costly. Therefore, there is a current need for mirror device that may be converted from a handheld mirror to a free-standing mirror that may be placed on a table or other surface.

In this respect, before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### BRIEF SUMMARY OF SOME EMBODIMENTS

One embodiment of the mirror device includes a handle portion, a connector portion, and a mirror. The handle portion has a first end and a second end having a groove. The connector portion is coupled to the handle portion and has a ball-shaped first end and a second end. The ball-shaped first end is disposed within the groove such that the connector portion may rotate with respect to the handle portion and is adjustable with respect to the second end of the handle portion such that the connector portion may be positioned vertically and perpendicularly with respect to the handle portion. The mirror is coupled to the second end of the connector portion such that the mirror may rotate in conjunction with the connector portion and may be angularly positioned with respect to the handle portion based on the angular position of the connector portion with respect to the handle portion.

Another embodiment of mirror device includes a handle portion, a connector portion, and a mirror. The handle portion has a first end and a second end having a groove therein. The groove comprises a substantially u-shaped region having a ball-shaped interior region. The connector portion may be coupled to the handle portion. The connector portion may have a ball-shaped first end and a second end. The ball-shaped first end may be secured within the u-shaped region. The connector portion may be adjustable with respect to the second end of the handle portion such that the connector portion may be positioned vertically and perpendicularly with respect to the handle portion. The mirror may be coupled to the second end of the connector portion such that the mirror may rotate in conjunction with the rotation of the connector portion and may be angularly positioned with respect to the handle portion based on the angular position of the connector portion with respect to the handle portion.

Another embodiment of mirror device includes a handle portion, a connector portion, and a mirror. The handle portion has a first end, a second end, and a support region disposed between the first end and the second end for assisting the user with holding the mirror device. The second end has a groove therein, the groove comprising a substantially u-shaped region having a ball-shaped interior region. The support region is configured to contact the surface of a user's hand formed by the index finger and the thumb finger while a user is gripping the handle portion. The connector portion is coupled to the handle portion. The connector portion may have a ball-shaped first end and a second end. The ball-shaped first end may be secured within the u-shaped region. The connector portion may be adjustable with respect to the second end of the handle portion such that the connector portion may be positioned vertically and perpendicularly with respect to the handle portion. The mirror may be coupled to the second end of the connector portion such that the mirror may rotate in conjunction with the rotation of the connector portion and may be angularly positioned with respect to the handle portion based on the angular position of the connector portion with respect to the handle portion.

There has thus been outlined the features of some embodiments of the invention in order that the detailed description thereof may be better understood, and in order that the present contribution to the art may be better appreciated. There are additional features of the embodiments of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of the embodiments of the invention.

FIG. 1 shows a side view of an embodiment of the adjustable mirror device in the self-standing orientation.

FIG. 2 shows a side view of an embodiment of the adjustable mirror device in the user-supported orientation.

FIG. 3 shows a side view of an embodiment of the adjustable mirror device in the user-supported orientation.

FIG. 4A shows a front view of an embodiment of the adjustable mirror device in the user-supported orientation, with the mirror parallel with respect to the handle portion.

FIG. 4B shows a front view of an embodiment of the adjustable mirror device in the user-supported orientation, with the mirror perpendicular with respect to the handle portion.

FIG. 5A shows a front view of an embodiment of the handle portion of an embodiment of the adjustable mirror device.

FIG. 5B shows a cross-section view of an embodiment of the handle portion taken at the line A-A′ as shown in FIG. 5A.

FIG. 6 shows a top view an embodiment of the adjustable mirror device.

### DETAILED DESCRIPTION OF SOME EMBODIMENTS

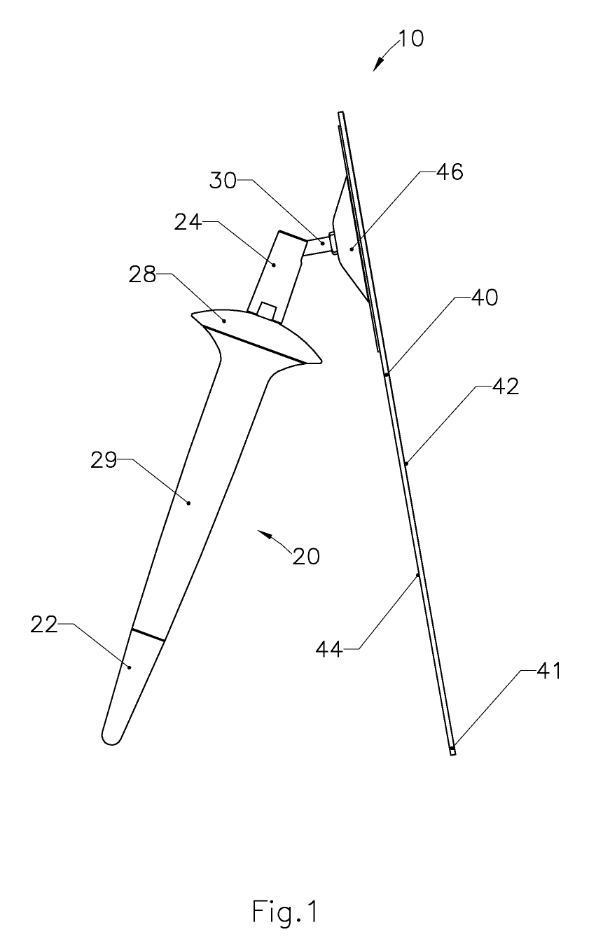

Referring now to the drawings, wherein similar parts are identified by like reference numerals, FIG. 1 shows a side view of an embodiment of the adjustable mirror device 10. Mirror 10 may include a handle portion 20, a connector portion 30, and a mirror 40. As shown, device 10 is in the self-standing orientation, where it may be placed on a table or other flat surface (not shown). In the self-standing orientation, distal end 41 of mirror 40 contacts a surface and is positioned opposite a first end 22 of handle portion 20.

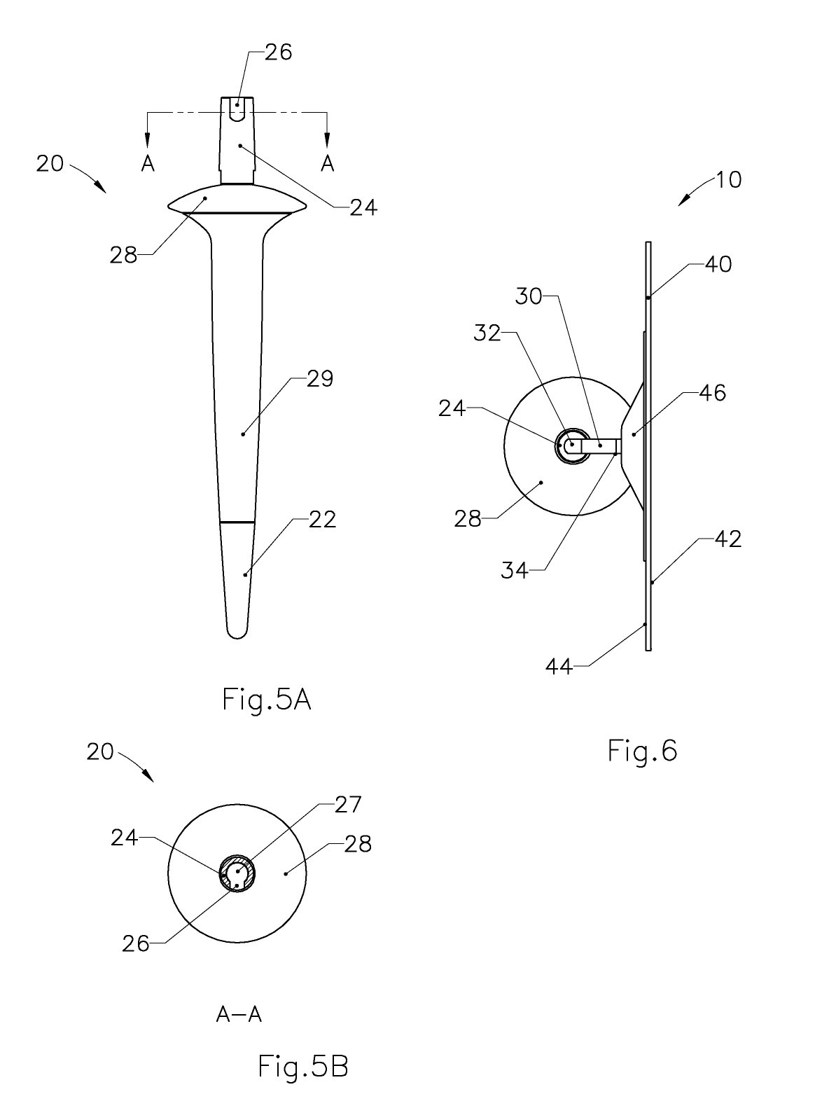

Handle portion 20 may have a first end 22 and a second end 24 having a groove 26 therein (see FIGS. 5A and 5B). Handle portion 20 may comprise various shapes and may be comprised of various materials. For example, handle portion 20 may be comprised of a metallic material and be substantially cylindrical in shape. In other embodiments, first end 22 and second end 24 may comprise various shapes. As an example, first end 22 may be conical in shape and second end 24 may be substantially cylindrical in shape. Handle portion 20 may further include a support region 28 disposed between first end 22 and second end 24. Support region 28 may assist a user with holding the device 10. In some embodiments, support region 28 may be configured to contact the surface of a user's hand formed by the index finger and the thumb finger while a user is gripping handle portion 20. As an example, support region 28 may be disk shaped, however other shapes may be used as recognized by one having ordinary skill in the art. In some embodiments, handle portion 20 may be partially or wholly covered by a non-metallic surface 29 to assist a user in grasping handle portion 20. For example, the portion of handle portion between first end 22 and support region 28 may be covered with a non-slip material, such as rubber.

Connector portion 30 may be coupled to handle portion 20 and may have a ball-shaped first end 32 and a second end 34. First end 32 may be disposed within groove 26 (see FIG. 6) such that connector portion 30 may rotate with respect to handle portion 20 and is adjustable with respect to second end 24 such that connector portion 30 may be positioned vertically and perpendicularly with respect to handle portion 20. Second end 34 may be configured to facilitate attachment of connector portion 30 to mirror 40. As an example, second end 34 may have a diameter that may be press-fit within an opening in mirror 40. Connector portion 30 may be comprised of various materials and may comprise various shapes. For example, connector portion 30 may be metallic and may be substantially cylindrical with a ball-shaped end.

Mirror 40 may contain a front surface 42 and a back surface 44. Front surface 42 may be comprised of a reflective material, such as glass. Back surface 44 may contain a connection region 46 disposed thereon. Connection region 46 may serve to provide a connection point for second end 34. Connection region 46 may protrude from mirror 40 or may be a specific region of back surface 44 having a connection means for second end 34. Mirror 40 may be coupled to second end 34 such that mirror 40 may rotate in conjunction with connector portion 30 and may be angularly positioned with respect to handle portion 20 based on the angular position of connector portion 30 with respect to handle portion 20. In some embodiments, mirror 40 may be coupled to connector portion 30 such that mirror 40 cannot rotate with respect to connector portion 30. Mirror 40 may comprise various shapes. For example, mirror 40 may be rectangular in shape.

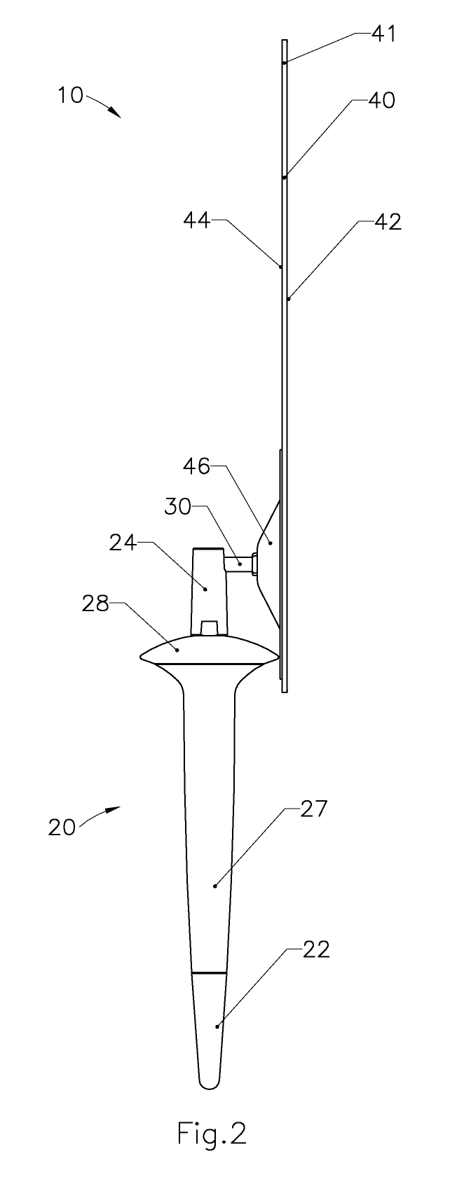

FIG. 2 shows a side view of device 10. As shown, device 10 is in the user-supported orientation, wherein a user may grasp device 10 by handle portion 20 and use device 10 as a handheld mirror. In the user-supported orientation, distal end 41 is positioned away from first end 22. In some embodiments, distal end 41 may be positioned 180 degrees apart from first end 22. Device 10 may be converted from the self-standing orientation (see FIG. 1) to a user-supported orientation by rotating mirror 40 in a parallel plane with respect to handle portion 20 (see FIGS. 4A and 4B).

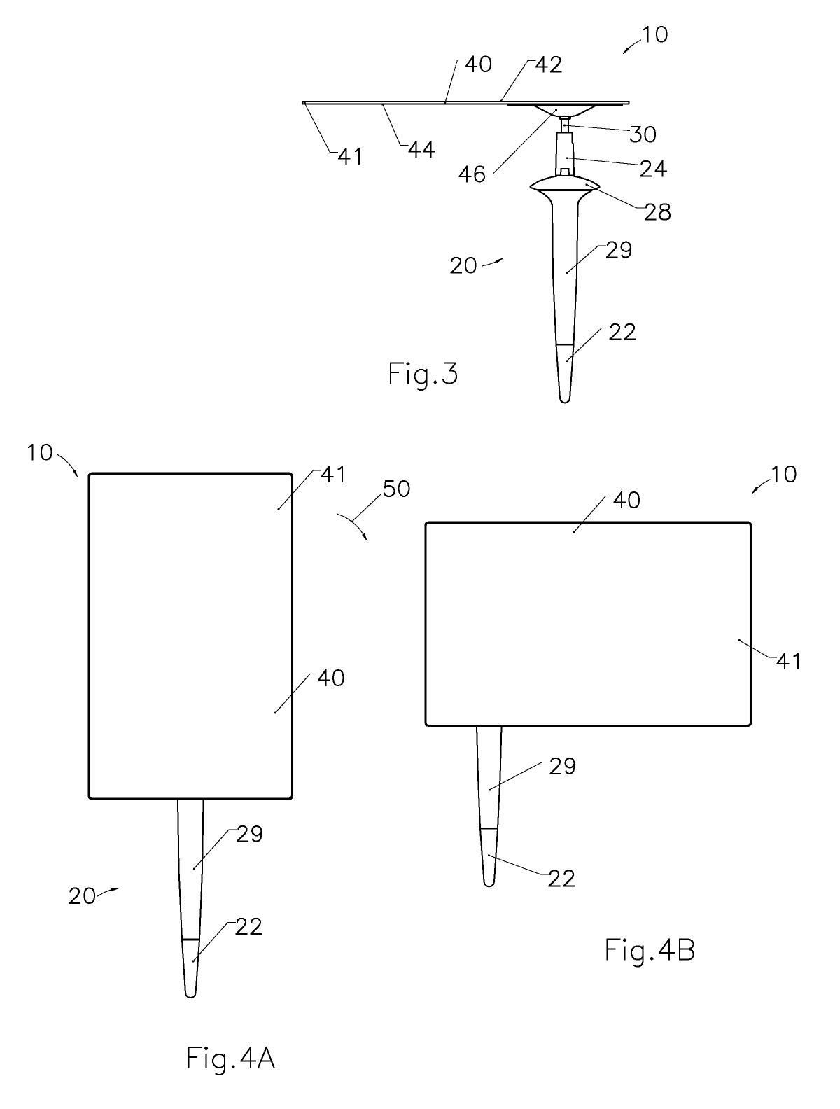

FIG. 3 shows a side view of device 10 in the user-supported orientation. To reach the orientation shown in FIG. 3, mirror 40 is rotated such that it lies within a perpendicular plane with respect to handle portion 20. In this orientation, connector portion 30 is parallel with respect to handle portion 20. The shape of groove 26 allows connector portion 30 to rotate with respect to handle portion 20. As an example, groove 26 may be u-shaped. In other embodiments, groove 26 may comprise other shapes wherein similar maneuverability of connector portion 30 with respect to handle portion 20 is provided. In some embodiments, groove 26 extends only to one portion of second end 24 such that connector portion 30 may only rotate between 0 degrees and 90 degrees with respect to second end 24 (for example, see FIG. 5B). In other embodiments, groove 26 extends to two portions of second end 24 such that connector portion 30 may rotate between 0 degrees and 180 degrees with respect to second end 24.

Referring to FIGS. 4A and 4B, FIG. 4A shows a front view of device 10 in the user-supported orientation with mirror 40 parallel with respect to handle portion 20, and FIG. 4B shows a front view of device 10 with mirror 40 perpendicular with respect to handle portion 20. To reach the orientation shown in FIG. 4B, mirror 40 is rotated in a plane parallel with respect to handle portion 20, from the position shown in FIG. 4A in the direction shown by arrow 50. First end 32 may be press-fit within groove 26 to allow mirror 40 to retain its orientation with respect to handle portion 20 during use.

Referring to FIGS. 5A and 5B, FIG. 5A shows a front view of handle portion 20 and FIG. 5B shows a cross-section view of handle portion 20 taken at the line A-A′ as shown in FIG. 5A. FIGS. 5A and 5B illustrate the shape of groove 26. Groove 26 may comprise various shapes. As an example, groove 26 may be shaped as a substantially u-shaped region. In other embodiments, groove 26 may be substantially u-shaped and may have a ball-shaped interior region 27 wherein ball-shaped first end 32 may be disposed therein to secure first end 32 within groove 26. FIG. 6 shows a top view of device 10, illustrating one embodiment of second end 24. In this embodiment, groove 26 is also u-shaped, in addition to the u-shaped region shown in FIG. 5A. FIG. 6 illustrates the partial covering of ball-shaped first end 32 by the tip of second end 24. The partial covering of first end 32 allows first end 32 to be securely positioned within groove 26 during rotation of mirror 40.

With respect to the above description it is to be realized that the optimum dimensional relationships for the parts of the invention, including variations in size, materials, shape, form, function and manner of operation, device, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the embodiments of the present invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the inventions of the application, which are measured by the claims, nor is it intended to be limiting as to the scope of the embodiments of the invention in any way.

What is claimed is:

1. A mirror device comprising:
a handle portion, the handle portion having a first end and a second end, the second end having a groove therein;
a connector portion coupled to the handle portion, the connector portion having a ball-shaped first end and a second end, the ball-shaped first end disposed within the groove such that the connector portion may rotate with respect to the handle portion and may be adjustable with respect to the second end of the handle portion such that the connector portion may be positioned vertically and perpendicularly with respect to the handle portion; and
a mirror coupled to the second end of the connector portion such that the mirror may rotate in conjunction with the rotation of the connector portion and may be angularly positioned with respect to the handle portion based on the angular position of the connector portion with respect to the handle portion.

2. The mirror device of claim 1, wherein the handle portion is substantially cylindrical in shape.

3. The mirror device of claim 1, wherein the first end is conical in shape.

4. The mirror device of claim 1, wherein the handle portion further includes a support region disposed between the first end and the second end for assisting the user with holding the mirror device, the support region configured to contact the surface of a user's hand formed by the index finger and the thumb finger while a user is gripping the handle portion.

5. The mirror device of claim 4, wherein the support region is disk shaped.

6. The mirror device of claim 1, wherein the second end is substantially cylindrical in shape and the groove comprises a substantially u-shaped region, the u-shaped region having a ball-shaped interior region wherein the ball-shaped first end may be disposed therein, the ball-shaped first end being secured within the u-shaped region.

6. The mirror device of claim 1, wherein the handle portion is covered by a non-metallic surface to assist a user in grasping the handle portion.

7. The mirror device of claim 1, wherein the handle portion is comprised of a metallic material.

8. The mirror device of claim 1, wherein the mirror is rectangular in shape.

9. The mirror device of claim 1, wherein the mirror is coupled to the connector portion such that the mirror cannot rotate with respect to the connector portion.

10. A mirror device comprising:
a handle portion, the handle portion having a first end and a second end, the second end having a groove therein, the groove comprising a substantially u-shaped region, the u-shaped region having a ball-shaped interior region;
a connector portion coupled to the handle portion, the connector portion having a ball-shaped first end and a second end, the ball-shaped first end being secured within the u-shaped region, the connector portion adjustable with respect to the second end of the handle portion such that the connector portion may be positioned vertically and perpendicularly with respect to the handle portion; and
a mirror coupled to the second end of the connector portion such that the mirror may rotate in conjunction with the rotation of the connector portion and may be angularly positioned with respect to the handle portion based on the angular position of the connector portion with respect to the handle portion.

11. The mirror device of claim 10, wherein the handle portion is substantially cylindrical in shape.

12. The mirror device of claim 10, wherein the first end is conical in shape.

13. The mirror device of claim 10, wherein the handle portion further includes a support region disposed between the first end and the second end for assisting the user with holding the mirror device, the support region configured to contact the surface of a user's hand formed by the index finger and the thumb finger while a user is gripping the handle portion.

14. The mirror device of claim 13, wherein the support region is disk shaped.

15. The mirror device of claim 10, wherein the handle portion is partially covered by a non-metallic surface to assist a user in grasping the handle portion.

16. The mirror device of claim 10, wherein the handle portion is comprised of a metallic material.

17. The mirror device of claim 10, wherein the mirror is coupled to the connector portion such that the mirror cannot rotate with respect to the connector portion.

18. A mirror device comprising:
a handle portion, the handle portion having a first end, a second end, and a support region disposed between the first end and the second end for assisting the user with holding the mirror device, the second end having a groove therein, the groove comprising a substantially u-shaped region having a ball-shaped interior region, the support region configured to contact the surface of a user's hand formed by the index finger and the thumb finger while a user is gripping the handle portion;
a connector portion coupled to the handle portion, the connector portion having a ball-shaped first end and a second end, the ball-shaped first end being secured within the u-shaped region, the connector portion adjustable with respect to the second end of the handle portion such that the connector portion may be positioned vertically and perpendicularly with respect to the handle portion; and
a mirror coupled to the second end of the connector portion such that the mirror may rotate in conjunction with the rotation of the connector portion and may be angularly positioned with respect to the handle portion based on the angular position of the connector portion with respect to the handle portion.

19. The mirror device of claim 18, wherein the handle portion is substantially cylindrical in shape, the first end is conical in shape, the support region is disk-shaped, and the mirror is rectangular in shape.

20. The mirror device of claim 18, wherein the handle portion is partially covered by a non-metallic surface to assist a user in grasping the handle portion.
